(19) United States
(12) Patent Application Publication
(10) Pub. No.: US 2025/0148269 A1
(43) Pub. Date: May 8, 2025

(54) APPARATUS AND METHOD FOR SEARCHING FOR NEURAL NETWORK ARCHITECTURE

(71) Applicant: ELECTRONICS AND TELECOMMUNICATIONS RESEARCH INSTITUTE, Daejeon (KR)

(72) Inventors: Ik-Soo SHIN, Daejeon (KR); Seon-Tae KIM, Daejeon (KR); Chang-Sik CHO, Daejeon (KR)

(73) Assignee: ELECTRONICS AND TELECOMMUNICATIONS RESEARCH INSTITUTE, Daejeon (KR)

(21) Appl. No.: 18/613,902

(22) Filed: Mar. 22, 2024

(30) Foreign Application Priority Data
Nov. 7, 2023 (KR) 10-2023-0152658

(51) Int. Cl. G06N 3/047

(52) U.S. Cl. CPC G06N 3/047

(57) ABSTRACT

Disclosed herein is an apparatus and method for searching for a neural network architecture. The apparatus calculates operator selection probability variables for respective layers based on candidate operators included in the respective layers in a supernet learning framework in which multiple layers are sequentially connected, calculates the result values of the multiple layers based on the operator selection probability variables, and selects any one of the candidate operators included in the multiple layers based on the result values.

### CROSS REFERENCE TO RELATED APPLICATION

This application claims the benefit of Korean Patent Application No. 10-2023-0152658, filed Nov. 7, 2023, which is hereby incorporated by reference in its entirety into this application.

### BACKGROUND OF THE INVENTION

### 1. Technical Field

The present disclosure relates generally to technology for training an Artificial Intelligence (AI) model, and more particularly to technology for searching for a neural network architecture.

### 2. Description of the Related Art

Neural Architecture Search (NAS) is a method for searching for the architecture and form of a neural network most suitable to solve a specific problem. A neural network in NAS may be generated by selecting and combining primitive operators configured with predefined operators and functions, referred to as a search space. Here, examples of the operators may include convolution, self-attention, multi-layer perceptron, and the like.

Meanwhile, Korean Patent Application Publication No. 10-2022-0125113, titled “Method and apparatus for neural architecture search”, discloses a method for performing neural architecture search (NAS) by receiving a pretrained first neural network, sampling the first neural network into a plurality of second neural networks, performing training using part of target data, and selecting a second neural network satisfying a predetermined condition.

### SUMMARY OF THE INVENTION

An object of the present disclosure is to derive efficient AI learning by searching for an optimized neural network architecture.

Another object of the present disclosure is to prevent learning interference from other operators in AI learning.

In order to accomplish the above objects, an apparatus for searching for a neural network architecture according to an embodiment of the present disclosure includes one or more processors and memory for storing at least one program executed by the one or more processors. The at least one program may calculate operator selection probability variables for respective layers based on candidate operators included in the respective layers in a supernet learning framework in which multiple layers are sequentially connected, calculate result values of the multiple layers based on the operator selection probability variables, and select any one of the candidate operators included in the multiple layers based on the result values.

Here, the candidate operators may be respectively assigned operator selection variables in advance.

Here, the operator selection variables may be generated to have an initial value of 0, which is a real number, and the operator selection probability variable may be calculated using the following conditional expression:

$${prob}_{j} = \frac{exp ( {x}_{j} )}{{\sum }_{i = 0}^{m - 1} exp ( {x}_{i} )} \qquad [ conditional expression ]$$

where m is the number of candidate operators in each layer, j is a number of each candidate operator, xᵢ is the operator selection variable, and probⱼ is the operator selection probability variable.

Here, the at least one program may transfer a result value calculated in any one of the multiple layers to a subsequent layer and calculate the result value of the subsequent layer using the transferred result value and the operator selection probability variable of the subsequent layer.

Here, the at least one program may calculate the result value of the subsequent layer by multiplying the sum of the operator section probability variable and a bias value by a value calculated by inputting the result value calculated in the any one of the multiple layers to a candidate operator selected in the subsequent layer.

Here, the bias value may be a fixed value that is preset so as not to be learned in a machine-learning process.

Here, the at least one program may generate subnets in which multiple candidate operators are selected for the respective layers, and may select candidate operators included in a subnet having the highest performance by comparing the results of evaluation of the performance of the subnets.

Here, the at least one program may receive input data for machine learning and perform machine learning using the supernet learning framework in which the candidate operators are selected.

Here, the at least one program may determine neural network loss based on a result of comparison of result data of the machine learning with label data corresponding to the input data.

Here, the at least one program may change connection weights and operator selection variables for the respective layers so as to minimize the neural network loss.

Also, in order to accomplish the above objects, a method for searching for a neural network architecture, performed by an apparatus for searching for a neural network architecture, according to an embodiment of the present disclosure includes calculating operator selection probability variables for respective layers based on candidate operators included in the respective layers in a supernet learning framework in which multiple layers are sequentially connected, calculating result values of the multiple layers based on the operator selection probability variables, and selecting any one of the candidate operators included in the multiple layers based on the result values.

Here, the candidate operators may be respectively assigned operator selection variables in advance.

Here, the operator selection variables may be generated to have an initial value of 0, which is a real number, and the operator selection probability variable may be calculated using the following conditional expression:

$${prob}_{j} = \frac{exp ( {x}_{j} )}{{\sum }_{i = 0}^{m - 1} exp ( {x}_{i} )} \qquad [ conditional expression ]$$

where m is the number of candidate operators in each layer, j is a number of each candidate operator, xᵢ is the operator selection variable, and probⱼ is the operator selection probability variable.

Here, calculating the result values may comprise transferring a result value calculated in any one of the multiple layers to a subsequent layer and calculating a result value of the subsequent layer using the transferred result value and the operator selection probability variable of the subsequent layer.

Here, calculating the result values may comprise calculating the result value of the subsequent layer by multiplying the sum of the operator section probability variable and a bias value by a value calculated by inputting the result value calculated in the any one of the multiple layers to a candidate operator selected in the subsequent layer. Here, the bias value may be a fixed value that is preset so as not to be learned in a machine-learning process.

Here, selecting the any one of the candidate operators may comprise generating subnets in which multiple candidate operators are selected for the respective layers and selecting candidate operators included in a subnet having the highest performance by comparing results of evaluation of the performance of the subnets.

Here, the method may further include receiving input data for machine learning before calculating the operator selection probability variables; and after selecting the any one of the multiple candidate operators, performing machine learning using the supernet learning framework in which the candidate operators are selected.

Here, the method may further include, after performing the machine learning, determining neural network loss based on a result of comparison of result data of the machine learning with label data corresponding to the input data.

Here, the method may further include, after determining the neural network loss, changing connection weights and operator selection variables for the respective layers so as to minimize the neural network loss.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for searching for a neural network architecture according to an embodiment of the present disclosure;

FIG. 2 is a block diagram illustrating an apparatus for searching for a neural network architecture including a machine-learning function according to an embodiment of the present disclosure;

FIG. 3 is a flowchart illustrating a method for searching for a neural network architecture according to an embodiment of the present disclosure;

FIG. 4 is a flowchart illustrating a method for searching for a neural network architecture including a machine-learning function according to an embodiment of the present disclosure; and

FIG. 5 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

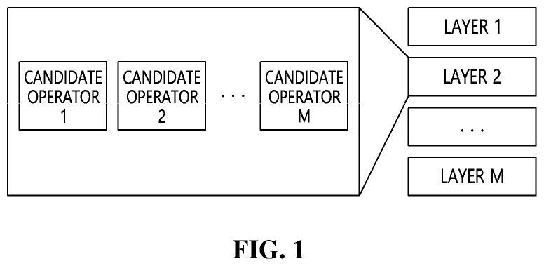

FIG. 1 is a block diagram illustrating an apparatus for searching for a neural network architecture according to an embodiment of the present disclosure.

Referring to FIG. 1, it can be seen that the apparatus for searching for a neural network architecture according to an embodiment of the present disclosure is represented as a supernet, which is a neural network formed by combining candidate operators into a single neural network. It can be seen that the supernet is configured with multiple layers. The supernet is yet to be trained, and connection weights in the candidate operators are yet to be determined. The candidate operators may include, for example, a 3×3 kernel-based convolution operation, a 5×5 kernel-based convolution operation, self-attention, and the like, but are not limited thereto. For each layer of the supernet, any one of the candidate operators included in the layer is selected, whereby the final architecture may be determined.

First, the apparatus for searching for a neural network architecture may calculate operator selection probability variables for respective layers based on candidate operators included in the respective layers in a supernet learning framework in which multiple layers are sequentially connected.

All of the candidate operators may be respectively assigned operator selection variables in advance. The operator selection variables may be generated to have an initial value of 0, which is a real number.

The operator selection variables may be calculated to be the operator selection probability variable for each layer through Equation (1) below:

$${prob}_{j} = \frac{exp ( {x}_{j} )}{{\sum }_{i = 0}^{m - 1} exp ( {x}_{i} )} \qquad ( 1 )$$

Here, m is the number of candidate operators in each layer, and j is a number of each candidate operator. xᵢ is the operator selection variable, and probⱼ is the operator selection probability variable.

Also, the apparatus for searching for a neural network architecture may calculate the result values of the multiple layers based on the operator selection probability variables.

The supernet may calculate the operator selection probability variable from the candidate operators included in the respective layers in the supernet neural network in which the multiple layers are sequentially connected.

$${X}_{n} = ( {prob}_{j} + {bias}_{j} ) * {ops}_{j} ( {X}_{n} - 1 ) \qquad ( 2 )$$

$${bias}_{j} = 1 - {prob}_{j} \qquad ( 3 )$$

In the supernet, the multiple layers may sequentially calculate the result values based on the operator selection probability variable.

Each layer may receive the result value of the previous layer as input, perform the operation process of the layer, as shown in Equation (2), and transfer the result thereof to the subsequent layer.

Xₙ₋₁ is the result value of the previous layer, Xₙ is the result value of the current layer, and opsⱼ is one of the candidate operators. Whenever input data is input by the supernet learning framework, one of the candidate operators may be selected as opsⱼ. The result value of the previous layer is input to opsⱼ, whereby the result may be output. Then, the result value of opsⱼ may be multiplied by the sum of the operator selection probability variable and a bias. The bias is calculated using the equation, (1−probⱼ), as shown in Equation (3). Finally, this value may be the operation result value of the corresponding layer. In Equation (2), the operator selection probability variable may be learned by the supernet learning framework, together with the weight parameters of the candidate operators, and the bias may be prevented from being learned.

The important thing is to include the operator selection probability variable in the equation of the i-th layer. It should be possible to learn the operator selection probability variable in the backward pass. The operator selection probability variable should not affect the result of ops.

$$forward : {X}_{i} = ( α + ( 1 - α ) ) * ops ( {X}_{i - 1} ) , α ∈ ( 0 , 1 ) \qquad ( 4 )$$

$$\begin{matrix}backward : \frac{\partial {X}_{i}}{\partial α} = ops ( {X}_{i - 1} ) + 0 - 0 \\ = ops ( {X}_{i - 1} )\end{matrix}$$

When the bias (1−probⱼ) is substituted with (1−α) in Equation (3), as shown in Equation (4), and when (1−α), which is the bias, is set to be not learned, the value of ops is not decreased in the forward pass, and α may be learned in the backward pass because

$$\frac{\partial {X}_{i}}{\partial α}$$

is present.

Here, the bias value may be a fixed value that is preset so as not to be learned in a machine-learning process.

Also, the apparatus for searching for a neural network architecture may select any one of the candidate operators included in the multiple layers based on the result value.

The architecture search framework may search for the optimal architecture by selecting the most suitable operator from among the candidate operators in each layer of the supernet that completes learning through the supernet learning framework.

For the search for the optimal architecture, one of two methods may be selected. The first method is to compare the operator selection probability variables assigned to the candidate operators for each layer and to thereby select the candidate operator having the highest value.

The second method is to use an evolutionary algorithm or reinforcement learning, which are generally often used in NAS.

For example, the evolutionary algorithm may arbitrarily select operators for respective layers at first. The neural network architecture formed of the selected operators may be referred to as a ‘subnet’.

Here, when the subnet is formed, the evolutionary algorithm may check the performance of the subnet according to the purpose of a user. After it checks the performance of the arbitrarily selected subnets several times in this way, the evolutionary algorithm may select a preset number of subnets having a performance value equal to or greater than a preset value.

Here, the evolutionary algorithm may arbitrarily select two subnets from among the selected subnets and exchange the candidate operators thereof.

Here, the evolutionary algorithm may generate subnets in which multiple candidate operators are selected for the respective layers, compare the results of evaluating the performance of the subnets, and select the candidate operators included in the subnet having the highest performance.

For example, assuming that the selection of candidate operators for respective layers of subnet A is (1, 3, 5, 2) and that the selection of candidate operators for respective layers of subnet B is (2, 4, 3, 1), when subnet C is formed whereby subnet A and subnet B exchange their candidate operators through the evolutionary algorithm, the following candidate operators may be selected for subnet C.
\textcircled{1} (1, 3, 3, 1) \textcircled{2} (2, 4, 5, 2) \textcircled{3} (1, 4, 5, 1)

In the case of \textcircled{1}, the first two operators are referred to from subnet A and the last two operators are referred to from subnet B. In the case of \textcircled{2}, the first two operators are referred to from subnet B and the last two operators are referred to from subnet A. In the case of \textcircled{3}, the first and third operators are referred to from subnet A and the second and fourth operators are referred to from subnet B.

Also, a new subnet may be formed by modifying subnet A or subnet B. For example, subnet D (1, 3, 2, 2) may be formed by changing only the third operator of subnet A.

The evolutionary algorithm may check the performance of multiple subnets by repeating this process. Among the results acquired by repeating this process several times, the subnet having the highest performance may be used as the final architecture.

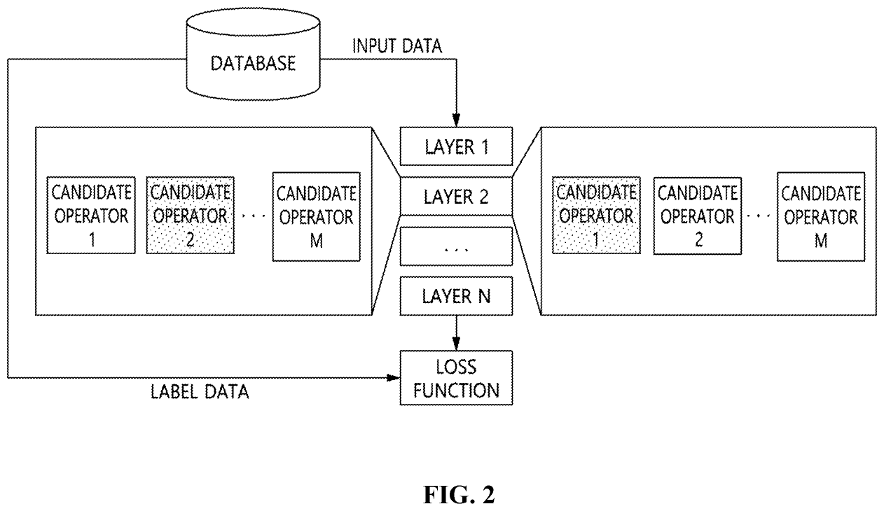

FIG. 2 is a block diagram illustrating an apparatus for searching for a neural network architecture including a machine-learning function according to an embodiment of the present disclosure.

Referring to FIG. 2, it can be seen that a machine-learning apparatus using the apparatus for searching for a neural network architecture according to an embodiment of the present disclosure includes a supernet learning framework corresponding to the apparatus for searching for a neural network architecture for training a single combined architecture and an architecture search framework for selecting the optimal architecture in the single combined architecture.

Here, the apparatus for searching for a neural network architecture according to an embodiment of the present disclosure includes components for machine learning, which are illustrated in FIG. 2, and may receive data, search for an optimal architecture, perform machine learning, determine neural network loss, and change an operator selection variable.

Here, the apparatus for searching for a neural network architecture may integrate candidate operators available for a neural network into a single neural network.

First, the apparatus for searching for a neural network architecture may receive input data for machine learning.

Also, the apparatus for searching for a neural network architecture may search for an optimal architecture.

Here, the process for searching for the optimal architecture may include the process described with reference to FIG. 1.

Also, the apparatus for searching for a neural network architecture may perform machine learning for a supernet using training data stored in a database through the supernet learning framework.

The machine learning may be performed using a supervised learning method, a semi-supervised learning method, or a self-supervised learning method. Through the learning process, the supernet learning framework may change the connection weights and the operator selection variables of the candidate operators according to the given purpose (e.g., object classification, object recognition, voice recognition, or the like). Learning may be performed using an adjustment algorithm, such as a stochastic gradient descent scheme, and a loss function. The training data used for learning may include input data input to the neural network and label data corresponding to the input data.

The supernet may output result data by processing the input data included in the training data.

Here, whenever the training data is input, the supernet may select one operator to be used in each layer.

Here, for each step, the selected operator may be randomly selected from among candidate operators included in each layer at the early stage of machine learning.

Here, as the machine learning progresses, the probabilities that the respective operators are to be selected may follow the operator selection probability variable of the candidate operator.

The selected operator receives the result output from the previous layer, and then the operation process of Equation (2) may be performed.

When a neural network is trained with all data once, this process is referred to as an epoch, and the process of performing training with an arbitrary number of pieces of data (a mini batch) once in an epoch may be referred to as a step.

The candidate operator of each layer may be randomly selected in each step, and may be more frequently selected as the value of the operator selection probability variable is greater.

Here, in the case of the candidate operator of each layer, one candidate operator may be selected and learned in each step while machine learning is being performed.

Here, at the early stage of learning, an operator may be randomly selected because the values of the operator selection probability variables of each layer are the same.

At the latter stage of the learning, as the value of the operator selection probability variable is learned, the operator having a high value as the value of the operator selection probability variable may be primarily selected for each layer.

Finally, after the learning is completed, the candidate operators having the highest value as the operator selection probability variable are selected for the respective layers, whereby the optimal architecture may be configured.

Accordingly, at the early stage of learning, the opportunity of learning an operator suitable for the learning may be stolen by the operator unsuitable for the learning, because the candidate operator is randomly selected. However, as the learning progresses, the operator suitable for the learning may more frequently participate in the learning as the value of the operator selection probability variable is higher.

Also, the apparatus for searching for a neural network architecture may determine neural network loss depending on the result of comparison of the result data of the machine learning with the label data corresponding to the input data.

Here, the supernet learning framework may determine the neural network loss based on the result of comparison between the result data output from the supernet and the label data.

Also, the apparatus for searching for a neural network architecture may change the connection weight and the operator selection variable of each layer so as to minimize the neural network loss.

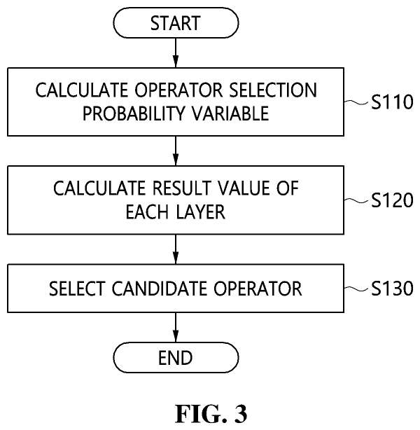

FIG. 3 is a flowchart illustrating a method for searching for a neural network architecture according to an embodiment of the present disclosure.

Referring to FIG. 3, in the method for searching for a neural network architecture according to an embodiment of the present disclosure, first, an operator selection probability variable may be calculated at step S110.

That is, at step S110, operator selection probability variables for respective layers may be calculated based on candidate operators included in the respective layers in a supernet learning framework in which multiple layers are sequentially connected.

All of the candidate operators may be respectively assigned operator selection variables in advance. The operator selection variables may be generated to have an initial value of 0, which is a real number.

The operator selection variables may be calculated to be the operator selection probability variable for each layer through Equation (1).

Here, m is the number of candidate operators in each layer, and j is a number of each candidate operator. xᵢ is the operator selection variable, and probⱼ is the operator selection probability variable.

Also, in the method for searching for a neural network architecture according to an embodiment of the present disclosure, a result value of each layer may be calculated at step S120.

That is, at step S120, the result values of the multiple layers may be calculated based on the operator selection probability variables.

Here, at step S120, the supernet may calculate the operator selection probability variable from the candidate operators included in the respective layers in the supernet neural network in which the multiple layers are sequentially connected.

Here, at step S120, the multiple layers may sequentially calculate the result values based on the operator selection probability variable in the supernet.

Here, at step S120, each layer may receive the result value of the previous layer as input, perform the operation process of the layer, as shown in Equation (2), and transfer the result thereof to the subsequent layer.

Xₙ₋₁ is the result value of the previous layer, and Xₙ is the result value of the current layer. opsⱼ is one of the candidate operators. Whenever input data is input by the supernet learning framework, one of the candidate operators may be selected as opsⱼ. The result value of the previous layer is input to opsⱼ, whereby the result may be output. Then, the result value of opsⱼ may be multiplied by the sum of the operator selection probability variable and a bias. The bias is calculated using the equation, (1−probⱼ), as shown in Equation (3). Finally, this value may be the operation result value of the corresponding layer. In Equation (2), the operator selection probability variable may be learned by the supernet learning framework, together with the weight parameters of the candidate operators, and the bias may be prevented from being learned.

The important thing is to include the operator selection probability variable in the equation of the i-th layer. It should be possible to learn the operator selection probability variable in the backward pass. The operator selection probability variable should not affect the result of ops.

When the bias (1−probⱼ) is substituted with (1−α) in Equation (3) above, as shown in Equation (4), and when (1−α), which is the bias, is set to be not learned, the value of ops is not decreased in the forward pass, and α may be learned in the backward pass because

$$\frac{\partial {X}_{i}}{\partial α}$$

is present.

Here, the bias value may be a fixed value that is preset so as not to be learned in a machine-learning process.

Also, in the method for searching for a neural network architecture according to an embodiment of the present disclosure, a candidate operator may be selected at step S130.

That is, at step S130, any one of the candidate operators included in the multiple layers may be selected based on the result value.

Here, at step S130, the architecture search framework may search for the optimal architecture by selecting the most suitable operator from among the candidate operators in each layer of the supernet that completes learning through the supernet learning framework.

For the search for the optimal architecture, one of two methods may be selected. The first method is to compare the operator selection probability variables assigned to the candidate operators for each layer and to thereby select the candidate operator having the highest value.

The second method is to use an evolutionary algorithm or reinforcement learning, which are generally often used in NAS.

For example, the evolutionary algorithm may arbitrarily select operators for respective layers at first. The neural network architecture formed of the selected operators may be referred to as a ‘subnet’.

Here, when the subnet is formed, the evolutionary algorithm may check the performance of the subnet according to the purpose of a user. After it checks the performance of the arbitrarily selected subnets several times in this way, the evolutionary algorithm may select a preset number of subnets having a performance value equal to or greater than a preset value.

Here, the evolutionary algorithm may arbitrarily select two subnets from among the selected subnets and exchange the candidate operators thereof.

Here, the evolutionary algorithm may generate subnets in which multiple candidate operators are selected for the respective layers, compare the results of evaluating the performance of the subnets, and select the candidate operators included in the subnet having the highest performance.

For example, assuming that the selection of candidate operators for respective layers of subnet A is (1, 3, 5, 2) and that the selection of candidate operators for respective layers of subnet B is (2, 4, 3, 1), when subnet C is formed whereby subnet A and subnet B exchange their candidate operators through the evolutionary algorithm, the following candidate operators may be selected for subnet C.
\textcircled{1} (1, 3, 3, 1) \textcircled{2} (2, 4, 5, 2) \textcircled{3} (1, 4, 5, 1)

In the case of \textcircled{1}, the first two operators are referred to from subnet A and the last two operators are referred to from subnet B. In the case of \textcircled{2}, the first two operators are referred to from subnet B and the last two operators are referred to from subnet A. In the case of \textcircled{3}, the first and third operators are referred to from subnet A and the second and fourth operators are referred to from subnet B.

Also, a new subnet may be formed by modifying subnet A or subnet B. For example, subnet D (1, 3, 2, 2) may be formed by changing only the third operator of subnet A.

The evolutionary algorithm may check the performance of multiple subnets by repeating this process.

Here, at step S130, among the results acquired by repeating this process several times, the subnet having the highest performance may be used as the final architecture.

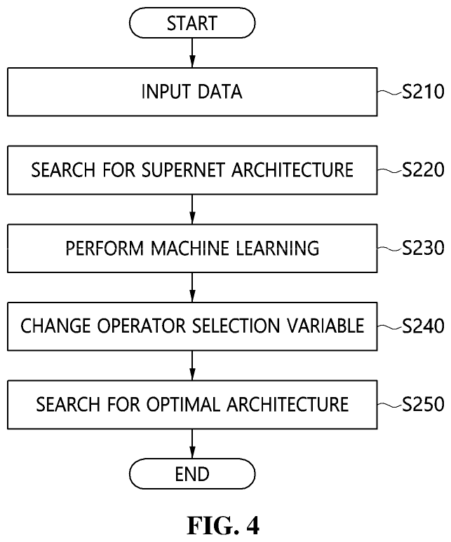

FIG. 4 is a flowchart illustrating a method for searching for a neural network architecture including a machine-learning function according to an embodiment of the present disclosure.

Referring to FIG. 4, in the method for searching for a neural network architecture including a machine-learning function according to an embodiment of the present disclosure, first, data for machine learning may be input at step S210.

Also, an apparatus for searching for a neural network architecture including a machine-learning function according to an embodiment of the present disclosure may search for a supernet architecture at step S220.

That is, step S220 may include the process described with reference to FIG. 1, which is the process of searching for an optimal architecture.

Here, at step S220, candidate operators available for a neural network may be integrated into a single neural network.

Also, the apparatus for searching for a neural network architecture including a machine-learning function according to an embodiment of the present disclosure may perform machine learning at step S230.

That is, at step S230, machine learning may be performed for the supernet using training data stored in a database through the supernet learning framework.

The machine learning may be performed using a supervised learning method, a semi-supervised learning method, or a self-supervised learning method. Through the learning process, the supernet learning framework may change the connection weights and the operator selection variables of the candidate operators according to the given purpose (e.g., object classification, object recognition, voice recognition, or the like). Learning may be performed using an adjustment algorithm, such as a stochastic gradient descent scheme, and a loss function. The training data used for learning may include input data input to the neural network and label data corresponding to the input data.

Here, at step S230, the input data included in the training data is processed, whereby result data may be output.

Here, at step S230, whenever the training data is input, one operator to be used in each layer may be selected.

Here, at step S230, for each step, the selected operator may be randomly selected from among candidate operators included in each layer at the early stage of machine learning.

Here, at step S230, as the machine learning progresses, the probabilities that the respective operators are to be selected may follow the operator selection probability variable of the candidate operator.

The selected operator receives the result output from the previous layer as input, and then the operation process of Equation (2) may be performed.

When a neural network is trained with all data once, this process is referred to as an epoch, and the process of performing training with an arbitrary number of pieces of data (a mini batch) once in an epoch may be referred to as a step.

The candidate operator of each layer may be randomly selected in each step, and may be more frequently selected as the value of the operator selection probability variable is greater.

Here, in the case of the candidate operator of each layer, one candidate operator may be selected and learned in each step while machine learning is being performed.

Here, at the early stage of learning, an operator may be randomly selected because the values of the operator selection probability variables of each layer are the same.

At the latter stage of the learning, as the value of the operator selection probability variable is learned, the operator having a high value as the value of the operator selection probability variable may be primarily selected for each layer.

Finally, after the learning is completed, the candidate operators having the highest value as the operator selection probability variable are selected for the respective layers, whereby the optimal architecture may be configured.

Accordingly, at the early stage of learning, the opportunity of learning an operator suitable for the learning may be stolen by the operator unsuitable for the learning, because the candidate operator is randomly selected. However, as the learning progresses, the operator suitable for the learning may more frequently participate in the learning as the value of the operator selection probability variable is higher.

Here, at step S230, the neural network loss may be determined based on the result of comparison of the result data of the machine learning with the label data corresponding to the input data.

Here, at step S230, the supernet learning framework may determine the neural network loss based on the result of comparison between the result data output from the supernet and the label data.

Also, the apparatus for searching for a neural network architecture including a machine-learning function according to an embodiment of the present disclosure may change the operator selection variable at step S240.

That is, at step S240, the connection weight and the operator selection variable of each layer may be changed such that the neural network loss is minimized.

Also, the apparatus for searching for a neural network architecture including a machine-learning function according to an embodiment of the present disclosure may search for an optimal architecture at step S250.

That is, at step S250, the apparatus for searching for a neural network architecture may select any one of the candidate operators included in the multiple layers based on the result value.

That is, at step S250, the architecture search framework may search for the optimal architecture by selecting the most suitable operator from among the candidate operators in each layer of the supernet that completes learning through the supernet learning framework.

Here, at step, for the search for the optimal architecture, one of two methods may be selected.

Here, at step, the first method is to compare the operator selection probability variables assigned to the candidate operators for each layer and to thereby select the candidate operator having the highest value.

Here, at step, the second method is to use an evolutionary algorithm or reinforcement learning, which are generally often used in NAS.

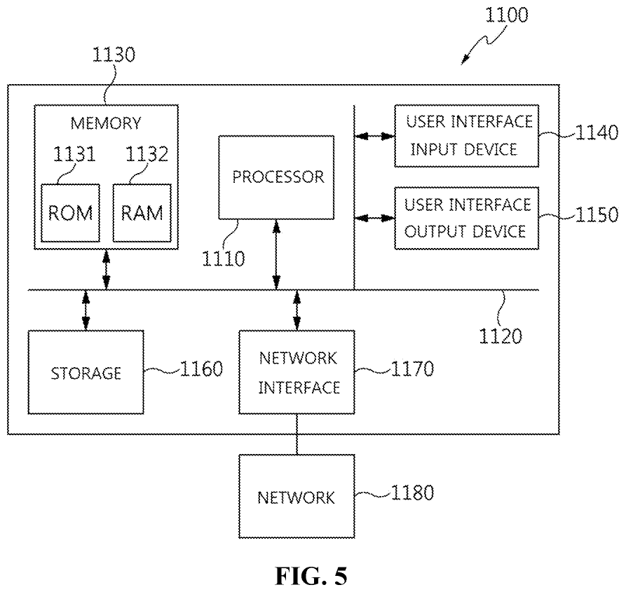

FIG. 5 is a view illustrating a computer system according to an embodiment of the present disclosure.

Referring to FIG. 5, the apparatus for searching for a neural network architecture according to an embodiment of the present disclosure may be implemented in a computer system 1100 including a computer-readable recording medium. As illustrated in FIG. 5, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for searching for a neural network architecture according to an embodiment of the present disclosure includes one or more processors 1110 and memory 1130 for storing at least one program executed by the one or more processors 1110. The at least one program may calculate operator selection probability variables for respective layers based on candidate operators included in the respective layers in a supernet learning framework in which multiple layers are sequentially connected, calculate result values of the multiple layers based on the operator selection probability variables, and select any one of the candidate operators included in the multiple layers based on the result values.

Here, the candidate operators may be respectively assigned operator selection variables in advance.

Here, the operator selection variables may be generated to have an initial value of 0, which is a real number, and the operator selection probability variable may be calculated using the following conditional expression:

$${prob}_{j} = \frac{exp ( {x}_{j} )}{{\sum }_{i = 0}^{m - 1} exp ( {x}_{i} )} \qquad [ conditional expression ]$$

where m is the number of candidate operators in each layer, j is a number of each candidate operator, xᵢ is the operator selection variable, and probⱼ is the operator selection probability variable.

Here, the at least one program may transfer a result value calculated in any one of the multiple layers to a subsequent layer and calculate the result value of the subsequent layer using the transferred result value and the operator selection probability variable of the subsequent layer.

Here, the at least one program may calculate the result value of the subsequent layer by multiplying the sum of the operator section probability variable and a bias value by a value calculated by inputting the result value calculated in the any one of the multiple layers to a candidate operator selected in the subsequent layer. Here, the bias value may be a fixed value that is preset so as not to be learned in a machine-learning process.

Here, the at least one program may generate subnets in which multiple candidate operators are selected for the respective layers, and may select candidate operators included in a subnet having the highest performance by comparing the results of evaluation of the performance of the subnets.

Here, the at least one program may receive input data for machine learning and perform machine learning using the supernet learning framework in which the candidate operators are selected.

Here, the at least one program may determine neural network loss based on a result of comparison of result data of the machine learning with label data corresponding to the input data.

Here, the at least one program may change connection weights and operator selection variables for the respective layers so as to minimize the neural network loss.

In the apparatus and method for searching for a neural network architecture according to an embodiment of the present disclosure, an operator selection probability variable may be included in the internal operation of a model.

The operator selection probability variable included in the internal operation of the model may be updated together with connection weights during a learning process. Therefore, an additional module or process for updating the operator selection probability variable is not required.

As the operator selection probability variable is updated, a more important operator may be used more frequently.

Also, in the apparatus and method for searching for a neural network architecture according to an embodiment of the present disclosure, a candidate operator may be sampled in each learning process.

Whenever input data is input, only one candidate operator is learned, whereby learning interference from another operator may be prevented.

Also, in the apparatus and method for searching for a neural network architecture according to an embodiment of the present disclosure, multiple candidate operators are not used at the same time, whereby the amount of computation for learning may be reduced.

Here, a bias may be included in the model by being added to the operator selection probability variable.

Because the bias, which is a variable that is not learned, is added to the operator selection probability variable, the operator selection probability variable may be updated although it does not affect the result of the candidate operator.

According to the present disclosure, efficient AI learning may be derived by searching for an optimized neural network architecture.

Also, the present disclosure may prevent learning interference from other operators in AI learning.

As described above, the apparatus and method for searching for a neural network architecture according to the present disclosure are not limitedly applied to the configurations and operations of the above-described embodiments, but all or some of the embodiments may be selectively combined and configured, so the embodiments may be modified in various ways.

What is claimed is:

1. An apparatus for searching for a neural network architecture, comprising:
one or more processors; and
memory for storing at least one program executed by the one or more processors,
wherein the at least one program
calculates operator selection probability variables for respective layers based on candidate operators included in the respective layers in a supernet learning framework in which multiple layers are sequentially connected,
calculates result values of the multiple layers based on the operator selection probability variables, and
selects any one of the candidate operators included in the multiple layers based on the result values.

2. The apparatus of claim 1, wherein the candidate operators are respectively assigned operator selection variables in advance.

3. The apparatus of claim 2, wherein the operator selection variables are generated to have an initial value of 0, which is a real number, and the operator selection probability variable is calculated through a conditional expression below:
$${prob}_{j} = \frac{exp ( {x}_{j} )}{{\sum }_{i = 0}^{m - 1} exp ( {x}_{i} )} \qquad [ conditional expression ]$$
where m is a number of candidate operators in each layer, j is a number of each candidate operator, xᵢ is the operator selection variable, and probⱼ is the operator selection probability variable.

4. The apparatus of claim 1, wherein the at least one program transfers a result value calculated in any one of the multiple layers to a subsequent layer and calculates a result value of the subsequent layer using the transferred result value and the operator selection probability variable of the subsequent layer.

5. The apparatus of claim 4, wherein the at least one program calculates the result value of the subsequent layer by multiplying a sum of the operator section probability variable and a bias value by a value calculated by inputting the result value calculated in the any one of the multiple layers to a candidate operator selected in the subsequent layer.

6. The apparatus of claim 5, wherein the bias value is a fixed value that is preset so as not to be learned in a machine-learning process.

7. The apparatus of claim 1, wherein the at least one program generates subnets in which multiple candidate operators are selected for the respective layers and selects candidate operators included in a subnet having highest performance by comparing results of evaluation of performance of the subnets.

8. The apparatus of claim 1, wherein the at least one program receives input data for machine learning and performs machine learning using the supernet learning framework in which the candidate operators are selected.

9. The apparatus of claim 8, wherein the at least one program determines neural network loss based on a result of comparison of result data of the machine learning with label data corresponding to the input data.

10. The apparatus of claim 9, wherein the at least one program changes connection weights and operator selection variables for the respective layers so as to minimize the neural network loss.

11. A method for searching for a neural network architecture, performed by an apparatus for searching for a neural network architecture, comprising:
calculating operator selection probability variables for respective layers based on candidate operators included in the respective layers in a supernet learning framework in which multiple layers are sequentially connected;
calculating result values of the multiple layers based on the operator selection probability variables; and
selecting any one of the candidate operators included in the multiple layers based on the result values.

12. The method of claim 11, wherein the candidate operators are respectively assigned operator selection variables in advance.

13. The method of claim 12, wherein the operator selection variables are generated to have an initial value of 0, which is a real number, and the operator selection probability variable is calculated through a conditional expression below:
$${prob}_{j} = \frac{exp ( {x}_{j} )}{{\sum }_{i = 0}^{m - 1} exp ( {x}_{i} )} \qquad [ conditional expression ]$$
where m is a number of candidate operators in each layer, j is a number of each candidate operator, xᵢ is the operator selection variable, and probⱼ is the operator selection probability variable.

14. The method of claim 11, wherein calculating the result values comprises transferring a result value calculated in any one of the multiple layers to a subsequent layer and calculating a result value of the subsequent layer using the transferred result value and the operator selection probability variable of the subsequent layer.

15. The method of claim 14, wherein calculating the result values comprises calculating the result value of the subsequent layer by multiplying a sum of the operator section probability variable and a bias value by a value calculated by inputting the result value calculated in the any one of the multiple layers to a candidate operator selected in the subsequent layer.

16. The method of claim 15, wherein the bias value is a fixed value that is preset so as not to be learned in a machine-learning process.

17. The method of claim 11, wherein selecting the any one of the candidate operators comprises generating subnets in which multiple candidate operators are selected for the respective layers and selecting candidate operators included in a subnet having highest performance by comparing results of evaluation of performance of the subnets.

18. The method of claim 11, further comprising:
before calculating the operator selection probability variables, receiving input data for machine learning; and
after selecting the any one of the multiple candidate operators, performing machine learning using the supernet learning framework in which the candidate operators are selected.

19. The method of claim 18, further comprising:
after performing the machine learning, determining neural network loss based on a result of comparison of result data of the machine learning with label data corresponding to the input data.

20. The method of claim 19, further comprising:
after determining the neural network loss, changing connection weights and operator selection variables for the respective layers so as to minimize the neural network loss.
